(19) United States
(12) Patent Application Publication
(10) Pub. No.: US 2016/0001681 A1
(43) Pub. Date: Jan. 7, 2016

(54) CHILD SAFETY SEAT

(71) Applicant: CYBEX GMBH, Bayreuth (DE)

(72) Inventor: Martin Pos, Bayreuth (DE)

(21) Appl. No.: 14/789,019

(22) Filed: Jul. 1, 2015

(30) Foreign Application Priority Data
Jul. 1, 2014 (DE) 102014109219.8

(51) Int. Cl. B60N 2/28

(52) U.S. Cl. CPC B60N 2/2884; B60N 2/2878; B60N 2/2851; B60N 2/2872

(57) ABSTRACT

A child safety seat with a seat region, a backrest and, if required, a headrest bordered laterally by side walls, in particular a child safety seat for babies or children up to 14 years, having a sitting/reclining shell with a head end and a foot end, which has raised side walls in side regions, wherein at least in the region of the side walls, at least one energy-absorbing measure is provided. The energy-absorbing measure is configured in the form of at least one energy-absorption unit arranged on a side wall of the seat region and/or the backrest and/or the headrest having deformation elements, in particular, deformation projections and/or recesses extending approximately perpendicularly and/or parallel to the extent of the side wall.

### CROSS-REFERENCE TO RELATED APPLICATION

This application claims priority to and the benefit of German Patent Application No. 10 2014 109 219.8 filed Jul. 1, 2014, the entire content of which is incorporated herein by reference.

### FIELD

Disclosed herein is a child safety seat with a seat region, a backrest and, if required, a headrest bordered laterally by side walls, in particular a child safety seat for babies and children up to 14 years, having a sitting/reclining shell with a head end and a foot end, which has raised side walls in side regions, wherein at least in the region of the side walls, at least one energy-absorbing measure is provided. The disclosure also relates to a child safety seat with a seat region, a backrest and, if required, a headrest bordered laterally by side walls.

Numerous child safety seats are known from the prior art. They serve, in particular, for the safe transport of children in vehicles such as motor vehicles. In the event of an accident involving the motor vehicle, the head of the baby or child situated in a child safety seat therein is an area that is particularly at risk. It is required, in particular, to undertake design precautions in order to protect the head of the child as well as possible in an accident involving the motor vehicle. In the region of the backrest and in the seat region of a child safety seat, such design precautions have also to be taken to be able to protect the baby or child as well as possible against forces acting on the baby or child along the back and seat region.

### SUMMARY

Embodiments disclosed herein provide a further developed child safety seat offering particularly good protection for a baby or a child up to 14 years old.

Embodiments provide a child safety seat with a seat region, a backrest and, if required, a headrest bordered laterally by side walls, in particular a child safety seat for babies and children up to 14 years, having a sitting/reclining shell with a head end and a foot end, which has raised side walls in side regions, wherein at least in the region of the side walls, at least one energy-absorbing measure is provided. In child safety seats, in the majority of cases, a headrest is provided as standard. Child safety seats for babies and children up to 14 years often have a sitting/reclining shell comprising a head end, a foot end and raised side walls in side regions. The child safety seat according to the disclosure is based thereon that at least in the region of the side walls, at least one energy-absorbing measure is provided.

The sitting/reclining shell can be made, for example, of plastics and/or metal and/or wood.

According to the disclosure, the at least one energy-absorbing measure is configured in the form of at least one energy-absorption unit arranged on a side wall of the seat region and/or the backrest and/or the headrest, having deformation elements, in particular, deformation projections and/or recesses extending approximately perpendicular and/or parallel to the extent of the side wall. In other words, the energy-absorbing measure is an energy-absorption unit which is provided at least at one side wall of the seat region and/or the backrest and/or the headrest. The at least one energy-absorption unit comprises deformation elements, in particular deformation projections and/or recesses extending approximately perpendicular and/or parallel to the extent of the side wall. The deformation elements, in particular the deformation projections and/or recesses can deform and absorb energy accordingly in an accident situation.

Due to the deformation, the impact energy is dissipated and the acceleration of body parts of the baby or child situated in the child safety seat is reduced.

The at least one energy-absorption unit can be provided in each case by a three-dimensionally shaped body made from a body, in particular a film, of plastics and/or cardboard and/or metal.

It is also possible that the three-dimensionally formed shaped body comprises a base surface and projections and/or recesses formed therefrom which are deformable on absorption of energy.

The projections and/or recesses can be configured, for example, peg-like or web-like. This is not a complete listing of the possible embodiments of the projections and/or recesses. A large number of configuration possibilities and/or geometrical forms are conceivable. For example, the projections and/or recesses can also be configured tubular. Preferably, the projections and/or recesses have a larger longitudinal extent than a transverse extent. The longitudinal extent defines the depth of the deformation elements or deformation projections and/or recesses extending approximately perpendicularly and/or parallel to a side wall. The transverse extent of the projections and/or recesses or of the deformation projections and/or recesses delimits the cross-section of these deformation elements. In the event of a collision, such projections and/or recesses or deformation projections and/or recesses can dissipate a very large proportion of the impact energy; for example, the acceleration of a body part of the baby or child, in particular the acceleration of the head of the baby or child, can be reduced by approximately half. At least at one edge of the base surface of the three-dimensionally formed shaped body, a side wall can be raised therefrom so that together with the base surface, a type of “absorption box or absorption cage” arises or is formed.

Preferably, side walls are formed and raised at least at two edges of the base surface of the three-dimensionally formed shaped body.

At least at one side wall of the three-dimensionally formed shaped body, there can extend web-like or peg-like or tube-like projections which thus also extend approximately perpendicularly to the extent of the side wall of the child safety seat, and therefore act similarly energy-absorbingly like the projections and/or recesses formed from the base surface.

Preferably, each energy-absorption unit is part of a separate side wall element, which at the side of the side wall of the backrest and/or the seat region and/or the headrest facing the body and/or head of the child is configured to be insertable therein and/or exchangeable.

In other words, the energy-absorption unit can be configured as a separate component which is insertable into a corresponding recess of the backrest and/or the seat region and/or the headrest and, if required, is exchangeable. In order to provide a secure fastening of the energy-absorption unit in a side wall and/or the seat region and/or the headrest, the energy-absorption unit can have fastening means which are configured corresponding to the fastening means of the side wall of the backrest and/or the seat region and/or the headrest. For example, the energy-absorption unit can be connected by means of a tongue-and-groove joint to the side wall or within a recess of the side wall. The configuration of a tongue-and-groove joint of this type can be variable, i.e. the groove can be provided either at the energy-absorption unit or in the side wall or in the cut-out of the side wall. The same applies for the tongue.

Particularly in the side walls of the seat region and/or the backrest and/or the headrest, at least two energy-absorption units are provided which are arranged facing one another symmetrically about an imaginary central longitudinal axis of the child seat. In particular, this applies for the configuration of an energy-absorbing measure in the region of the side wall or side cheek of a headrest; this is because it is primarily required to protect the head of a baby or a child during a collision.

The object described in relation to a further-developed child safety seat for a baby or a child up to 14 years is achieved in the context of a subsidiary aspect by a child safety seat according to claim 8.

According to this claim, there is provided a child safety seat with a seat region, a backrest and, if required, a headrest bordered laterally by side walls, in particular a child safety seat for babies and children up to 14 years, having a sitting/reclining shell with a head end and a foot end, which has raised side walls in side regions, wherein at least in the region of the side walls, at least one energy-absorbing measure is provided.

The sitting/reclining shell can be made, for example, of plastics and/or metal and/or wood.

According to the disclosure, the energy-absorbing measure is configured in the form of at least one energy-absorption unit arranged at a side wall of the seat region and/or the backrest and/or the headrest, and is manufactured, in each case, from a box-like or cage-like shaped body made, in particular, of a film, plastics and/or cardboard and/or metal with projections and/or recesses formed from the base or bottom surface and/or with perforations formed in base and/or side surfaces and can be used as a separate component in the side wall of the seat region and/or the backrest and/or the headrest. Thus, according to an embodiment, the energy-absorption unit can be configured as a box-like or cage-like shaped element which has projections and/or recesses formed from the base or bottom surface and/or perforations formed in the base and/or side surfaces.

The box-like or cage-like shaped form of the body made of plastics and/or cardboard and/or metal or a film of plastics and/or cardboard and/or metal can thus also have perforations provided only in the base and/or side surfaces. The perforations provided enable a previously defined deformation of the base and/or side surfaces so that, due to the deformation of the base and/or side surfaces, an impact energy acting in the event of a collision is dissipated and the acceleration of the body parts of the baby and/or child situated in the child safety seat is reduced.

The perforations can also be referred to as recesses. The perforations or recesses can have a round and/or elliptical and/or rectangular and/or square and/or polygonal cross-section. The arrangement of the cut-outs or perforations relative to one another can be configured variably. Preferably, at least three, particularly at least four, particularly at least five, particularly at least six, particularly at least seven perforations or recesses are provided in the energy-absorption unit. The arrangement of the perforations or recesses relative to one another is preferably carried out in such a manner that the base and/or side surface provided with the perforations or recesses is maximally deformable in the event of a collision and thus can dissipate the greatest possible impact energy.

Each energy-absorption unit can be part of a separate side wall element which is insertable into the side wall of a backrest and/or a seat region and/or a headrest and is exchangeable if required. The side wall of a backrest and/or a seat region and/or a headrest can have a cut-out or recess at each of the sides facing one another, into which the energy-absorption unit can be inserted.

For this purpose, the energy-absorption unit can be provided with fastening means which are configured corresponding to fastening means of the side wall of the backrest and/or the seat region and/or the headrest. For example, the corresponding fastening means can be the aforementioned tongue-and-groove joint. Consequently, a child safety seat can be constructed with at least one exchangeable energy-absorption unit. Following a collision and a deformation of the energy-absorption unit, the child safety seat can therefore be provided with a new energy-absorption unit.

Particularly in the side walls of the seat region and/or the backrest and/or the headrest, at least two energy-absorption units are provided which are arranged facing one another symmetrically about an imaginary central longitudinal axis of the child seat. This applies, in particular, for the configuration of an energy-absorbing measure in the region of the side wall or side cheek of a headrest.

Further embodiments are disclosed in the subclaims and combinations thereof.

### BRIEF DESCRIPTION OF THE DRAWINGS

The disclosure will now be described based upon an exemplary embodiment, making reference to the figures, in which:

FIG. 1a shows a side wall or side cheek of a headrest configured according to the disclosure with an integrated energy-absorption unit, in a perspective view;

FIGS. 1b and c show the side cheek according to FIG. 1 of a headrest in which the energy-absorption unit is removed, seen in a side view and an oblique view;

FIGS. 2a, b show an energy-absorption unit as part of the side cheek of FIG. 1, in a side view and an interior view; and

FIG. 3 shows a lateral plan view of an energy-absorption unit according to a further embodiment.

### DETAILED DESCRIPTION

In the following description, the same reference signs are used for the same and similarly-acting parts.

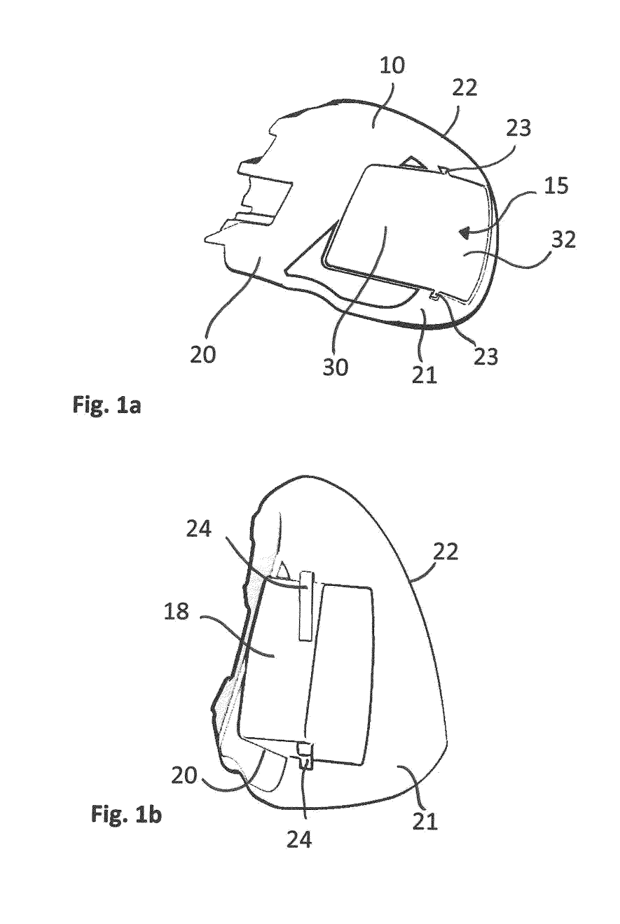

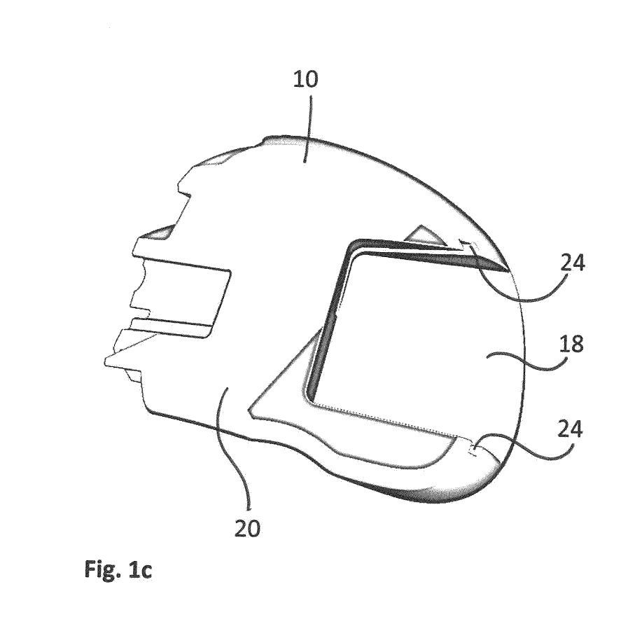

FIG. 1 shows a side cheek 10 of a headrest configured according to the disclosure, wherein the side cheek 10 of a headrest can be designated the side wall of a headrest. The headrest according to the disclosure has at least one energy-absorbing measure in the region of each side wall or in the region of each side cheek 10. This energy-absorbing measure is configured in the form of an energy-absorption unit 15 arranged at a side wall or side cheek 10 of the headrest. In the embodiment shown, the energy-absorption unit 15 is a separate component or is to be understood as a separate side wall element. The energy-absorption unit 15 is arranged on the side 20 of the side cheek 10 facing the head of the baby or child. The energy-absorption unit 15 is inserted, flush with the surface, into the side cheek 10. The free surface of the energy-absorption unit 15 facing the head of a child is therefore flush with the corresponding surface 21 of the side cheek 10.

The energy-absorption unit 15 can be provided in each case by a three-dimensionally shaped body made from a body, in particular a film, of plastics and/or cardboard and/or metal. The energy-absorption unit 15 can be formed, for example, from the same material as the side cheek 10. In this regard, a different choice of material is also conceivable. The energy-absorption unit 15 is to be understood, in the example shown, as a separate component. This is therefore a separate side wall element or the energy-absorption unit 15 is insertable into the side wall or side cheek 10 of the headrest. It is therefore possible to exchange defective energy-absorption units 15 or used energy-absorption units 15 and to replace them with new or undamaged energy-absorption units. In order to enable locking of the energy-absorption unit 15 to the side cheek 10 of the headrest, the energy-absorption unit 15 has fastening means 23. Said fastening means 23 correspond to fastening or locking means 24 of the side cheek 10 or side wall (see FIG. 1b).

In the example shown, the fastening or locking of the energy-absorption unit 15 at the side wall 10 is realised by means of a tongue-and-groove joint. The fastening means 23 of the energy-absorption unit 15 is configured, according to the embodiment shown in FIGS. 1a to 1c as an elongate tongue. Cut-outs or grooves 24 corresponding to the tongues 23 are formed in a recess 18 of the side cheek 10.

It is theoretically conceivable also to configure the tongue-and-groove joint in the reverse arrangement, i.e. so that the tongue is formed on the side cheek 10, particularly within the recess 18, whereas the energy-absorption unit 15 is provided with corresponding grooves.

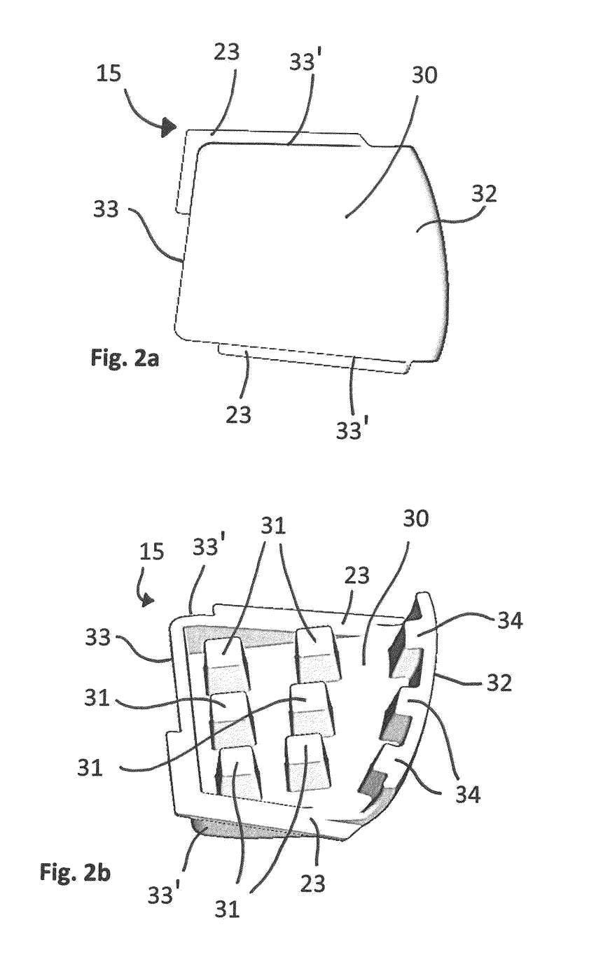

It is clear from FIGS. 2a and 2b that the energy-absorption unit 15 is configured as a three-dimensionally shaped body. The energy-absorption unit 15 can be provided, for example, by shaping a body, in particular a film, of plastics and/or cardboard and/or metal. The three-dimensionally formed shaped body has a base surface 30 and projections 31 formed from this base surface 30. The projections 31 are deformable on absorption of energy. The projections 31 are configured peg-like, i.e. the base surface of the projections is configured essentially square. The longitudinal extent or depth of the projections 31 formed is larger than the transverse extent, i.e. greater than their base surface cross-section.

The deformation projections 31 are configured, for example, hollow when shaped from a film. The filling of the projections 31 with plastically deformable material, e.g. PU foam or the like is conceivable. In the example shown, the deformation projections 31 extend approximately perpendicularly to the base surface 30 of the energy-absorption unit 15. In alternative embodiments, it is also conceivable that the deformation projections extend approximately parallel to the base surface of an energy-absorption unit. Since the base surface 30 extends approximately parallel to the side 20 of the side cheek 10 facing the head of a child (see FIG. 1a), the projections 31 are therefore oriented approximately perpendicularly to the extent of the side wall or side cheek 10. A side wall 32 is raised at the right-hand edge, as illustrated in FIG. 2b, of the base surface 30 of the three-dimensionally formed shaped body or the energy-absorption unit 15. A side wall 33 is also raised at the side of the base surface 30 opposite to the side wall 32. Together with the side walls 33′ extending transversely thereto, a three-dimensionally formed shaped body in the manner of an absorption box or absorption cage is formed. On the side of the base surface 30 facing toward the head, the openings formed there are closed toward the deformation projections 31 by a cover film, so that a continuous smooth surface results on this side (see FIG. 1a). Alternatively or partially, the surface can also be configured structured and/or roughened.

On the right-hand side wall 32 as seen in FIG. 2b, web-like projections 34 are configured or formed, extending approximately parallel to the projections 31 formed from the base surface 30. The three web-like projections 34 are an integral component of the side wall 32 and therefore form part of the side wall 32. These web-like projections 34 are also deformable on absorption of energy. Overall, therefore, the energy-absorption unit 15 has nine projections, wherein six are deformation projections 31 formed from the base surface 30 and three projections 34 are formed from the side wall 32.

The energy-absorption unit 15 or the three-dimensionally formed shaped body has an essentially rectangular form, wherein one side wall 32 extends slightly bowed according to the contour of the associated side wall or side cheek 10 of the headrest in the region of the recess, into which the energy-absorption unit 15 is to be inserted.

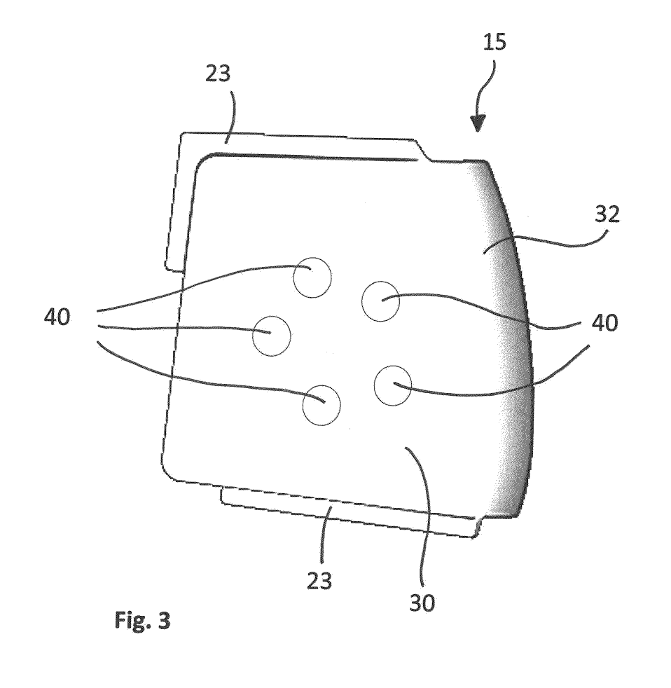

FIG. 3 shows a further embodiment of an energy-absorption unit. This is configured as a box-like or cage-like shaped body made of plastics and/or cardboard and/or metal, wherein perforations 40 are formed in the base surface 30 of the energy-absorption unit 15. For example, it is conceivable that the box-like or cage-like shaped body is originally a film.

The perforations or cut-outs or recesses can be similarly formed. In the exemplary embodiment shown, the perforations 40 are each configured circular. The five circular perforations 40 in FIG. 3 are configured lying approximately on a circular line. The energy-absorption unit 15 shown can additionally be configured with projections and/or recesses formed from the base or bottom surface 30. The formation of perforations and/or projections and/or recesses in the region also of the side walls 32 of the box-like energy-absorption unit 15 which are raised on all sides is conceivable.

The circular configuration of the perforations 40 is merely an exemplary illustration. The perforations can also have rectangular and/or elliptical and/or square and/or polygonal cross-sections. The arrangement of the perforations 40 to one another is also variable and can be designed to be, for example, dependent on the position of the energy-absorption unit 15 in the child safety seat according to the disclosure.

The embodiment of a possible energy-absorption unit 15 shown in FIG. 3 is configured as a separate component and is therefore insertable into the side wall or into the side cheek 10 of a headrest.

It should be noted here that all the parts described above in relation to the embodiments according to FIGS. 1a-3 are claimed as essential to the disclosure considered alone or in any combination, in particular the details shown in the drawings. In particular, energy-absorption units of the type described can also be arranged at suitable sites of the side and/or rear wall of a child seat.

### LIST OF REFERENCE NUMBERS

10 Side cheek/side wall
15 Energy-absorption unit
18 Recess
20 Side facing away from head
21 Front surface
22 Side facing toward head
23 Fastening means for energy-absorption unit
24 Fastening means for side cheek
30 Base surface
31 (Deformation) projections
32 Side wall
33, 33′ Side wall
34 Projections
40 Perforation

1. A child safety seat with a seat region, a backrest and, if required, a headrest bordered laterally by side walls, in particular a child safety seat for babies and children up to 14 years, having a sitting/reclining shell with a head end and a foot end, which has raised side walls in side regions, wherein at least in the region of the side walls of the child safety seat, at least one energy-absorbing measure is provided,
wherein
the energy-absorbing measure is configured in the form of at least one energy-absorption unit arranged on a side wall of the seat region and/or the backrest and/or the headrest, having deformation elements, in particular, deformation projections and/or recesses extending approximately perpendicular and/or parallel to the extent of the side wall.

2. The child safety seat according to claim 1, wherein
the energy-absorption unit is configured as a three-dimensionally formed shaped body preferably made from a body, in particular a film, of plastics and/or cardboard and/or metal.

3. The child safety seat according to claim 2, wherein
the three-dimensionally formed shaped body comprises a base surface and deformation projections and/or recesses formed therefrom which are deformable on absorption of energy.

4. The child safety seat according to claim 1, wherein
the deformation projections and/or recesses are configured tubular, peg-like or web-like.

5. The child safety seat according to claim 3, wherein
at least at one edge of the base surface of the three-dimensionally formed shaped body, a side wall is raised therefrom so that a type of “absorption box or absorption cage” is formed.

6. The child safety seat according to claim 5, wherein
on the at least one side wall, web-like projections are configured or formed, extending approximately parallel to the deformation projections and/or recesses formed from the base surface.

7. The child safety seat according to claim 1, wherein
the energy-absorption unit can be part of a separate side wall element which is insertable into the side wall of the backrest and/or the seat region and/or the headrest.

8. A child safety seat with a seat region, a backrest and, if required, a headrest bordered laterally by side walls, in particular a child safety seat for babies and children up to 14 years, having a sitting/reclining shell with a head end and a foot end, which has raised side walls in side regions, wherein at least in the region of the side walls, at least one energy-absorbing measure is provided,
wherein
the energy-absorbing measure is configured in the form of at least one energy-absorption unit arranged at a side wall of the seat region and/or the backrest and/or the headrest, and is manufactured, in each case, from a box-like or cage-like shaped body made, in particular, of a film, of plastics and/or cardboard and/or metal with projections and/or recesses formed from the base or bottom surface and/or with perforations formed in base and/or side surfaces.

9. The child safety seat according to claim 8, wherein
each energy-absorption unit is part of a separate side wall element which is insertable into the side wall of the backrest and/or the seat region and/or the headrest and is exchangeable.
